(19) United States
(12) Patent Application Publication
(10) Pub. No.: US 2006/0269046 A1
(43) Pub. Date: Nov. 30, 2006

(54) X-ray system including an assigned solid state detector, and a method for acquiring and displaying an X-ray image

(76) Inventor: Thomas Schmitt, Forchheim (DE)

Correspondence Address: HARNESS, DICKEY & PIERCE, P.L.C., P.O.BOX 8910, RESTON, VA, 20195, US

(21) Appl. No.: 11/412,800

(22) Filed: Apr. 28, 2006

(30) Foreign Application Priority Data
Apr. 29, 2005 (DE) 10 2005 020 124.5

(51) Int. Cl. H05G 1/64

(52) U.S. Cl. 378/98.8

(57) ABSTRACT

To render a simple diagnosis by way of a customary display easier for a user, an X-ray system is disclosed. The system includes an assigned solid state detector, an X-ray source to produce an X-ray beam, a device for image recognition, a device for image processing and a display apparatus. An X-ray image of an organ is read out from the solid state detector and detected by the device for image recognition. With regard to a locational position of the organ on the X-ray image, it is automatically displayed pictorially on the display apparatus by use of the device for image processing in such a way that the organ on the X-ray image exhibits a prescribable display position.

The present application hereby claims priority under 35 U.S.C. § 119 on German patent application number DE 10 2005 020 124.5 filed Apr. 2005, the entire contents of which is hereby incorporated herein by reference.

### FIELD

The invention generally relates to an X-ray system including an assigned, for example a mobile, solid state detector, and/or to a method for acquiring and displaying an X-ray image.

### BACKGROUND

Solid state detectors based on active read out matrices, for example made from amorphous silicon (a-Si) have been known for some years for the purpose of X-ray imaging. Image information is converted in an X-ray converter, for example cesium iodide (CsI), stored in photodiodes of the read out matrix as electric charge and subsequently read out via an active switching element with dedicated electronics and subjected to analog-digital conversion.

Also known are solid state detectors that can be used in mobile fashion, can be assigned to different X-ray systems, and can be positioned flexibly relative to the respective X-ray system. Mobile solid state detectors transmit data from X-ray images of an organ, for example by means of a connecting cable or, without cables, by radio to the X-ray system. Because of the flexible positioning of the solid state detector, in the event of being displayed on a display apparatus associated with the X-ray system such as, for example, a monitor, the organ on the X-ray image is frequently not in the display position desired by a user.

### SUMMARY

It is an object of at least one embodiment of the present invention to facilitate a diagnosis for the user with the aid of X-ray images acquired by way of a solid state detector, in particular a mobile one.

An object is achieved according to at least one embodiment of the invention by an X-ray system including an assigned, for example mobile, solid state detector, and/or by a method for acquiring and displaying an X-ray image.

Even when use is made of a mobile solid state detector that can be positioned flexibly and acquires an X-ray image of an organ arranged in any desired locational position on the solid state detector, the inventive X-ray system and the inventive method ensure a pictorial display of the organ on the X-ray image in a prescribed display position automatically and without manual intervention by the user such that a simple diagnosis by way of the accustomed display is facilitated for the user.

In an advantageous way for a particularly quick detection of the locational position of the organ on the X-ray image, the X-ray system has an additional position detection system for detecting the locational position of the organ on the X-ray image. According to one refinement of at least one embodiment of the invention, the device for image recognition exhibits a detection of the locational position of the organ with the aid of the outer contours and/or the area and/or the surface of the organ on the X-ray image.

According to a further refinement of at least one embodiment of the invention, the device for image recognition includes a prior identification of the organ as basis for the detection of the locational position of the organ on the X-ray image. In an advantageous way, the device for image recognition uses information relating to the respective image acquisition parameters in order to identify the organ.

An organ of a patient is to be understood here both as an organ in the actual sense, that is to say a heart or a lung, and as another body part such as, for example a hand or a cranium. In the present text, the exact position, desired by a user, of the organ on the image or X-ray image output on the display apparatus is denoted as display position. In the present text, the position of the organ on the solid state detector and thus on the X-ray image in relation, for example, to a detector orientation point is denoted as the locational position.

### BRIEF DESCRIPTION OF THE DRAWINGS

Embodiments of the invention and further advantageous refinements in accordance with additional features are explained in more detail below in the drawing with the aid of schematically illustrated example embodiments, without thereby restricting the invention to these example embodiments; in the drawings:

FIG. 1 shows a schematic of an X-ray system having an assigned mobile solid state detector according to the prior art;

FIG. 2 shows a plan view of the mobile solid state detector according to FIG. 1 with an organ to be imaged in a first locational position;

FIG. 3 shows a plan view of the mobile solid state detector according to FIG. 1 with an organ to be imaged in a second locational position;

FIG. 4 shows a plan view of a display apparatus with an X-ray image of the organ, in a display position, and

FIG. 5 shows a schematic of an inventive X-ray system having an assigned mobile solid state detector and a position detection system.

### DETAILED DESCRIPTION OF THE EXAMPLE EMBODIMENTS

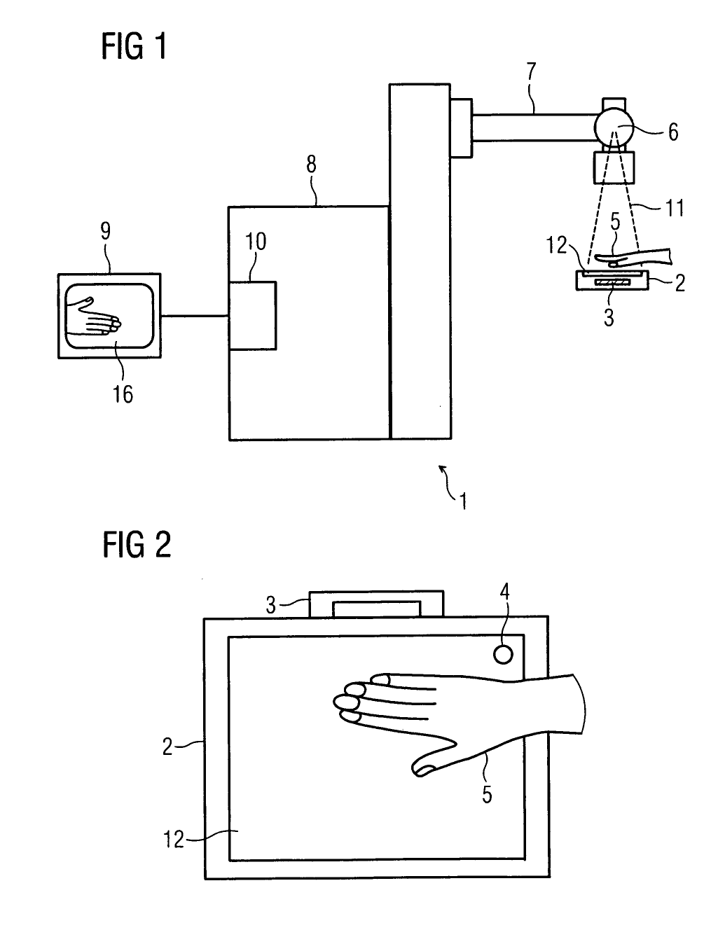

FIG. 1 shows a known X-ray system 1 having a control device 8, an X-ray source 6 fastened on a support arm 7, a processing and storage unit 10, a display apparatus 9 and a mobile solid state detector 2. The mobile, transportable solid state detector 2 can be assigned to the X-ray system 1 for the acquisition of an X-ray image of an organ, for example a right hand 5, transirradiated by an X-radiation 11. The X-ray image is read out electronically by the solid state detector 2 and transmitted to the control device 8 and the associated processing and storage unit 10, for example an operational computer, of the X-ray system 1 either without cables, for example by radio, or by means of a cable connection that can be attached.

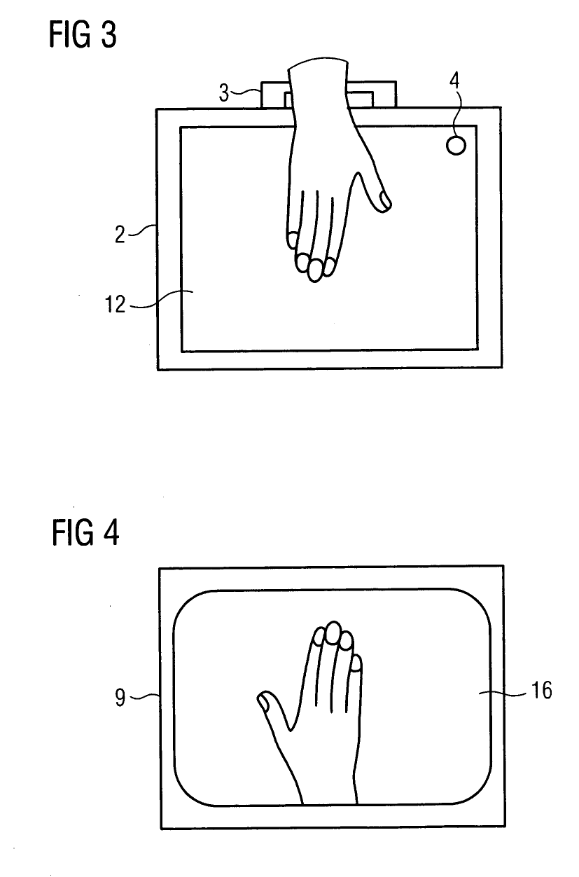

Because of its mobility, the mobile solid state detector 2 can be arranged during the X-raying in various orientations relative to the X-ray system 1, that is to say, for example, with a carry handle 3 to the left, right, in front or behind, the active area 12, always, of course, directly facing the X-ray beam 11. Likewise, the organ in the form of the right hand 5 can also be arranged in various locational positions on the active area 12, as is shown in FIG. 2 and FIG. 3, for example. The latter problem likewise occurs with stationary solid state detectors.

With the palm facing the solid state detector 2, the right hand 5 extends in FIG. 2 from the short side, adjacent to a detector orientation point 4, in the direction of the opposite short side. With the palm facing the solid state detector 2, the right hand 5 extends in FIG. 3 from the long side, adjacent to the detector orientation point 4, in the direction of the opposite long side.

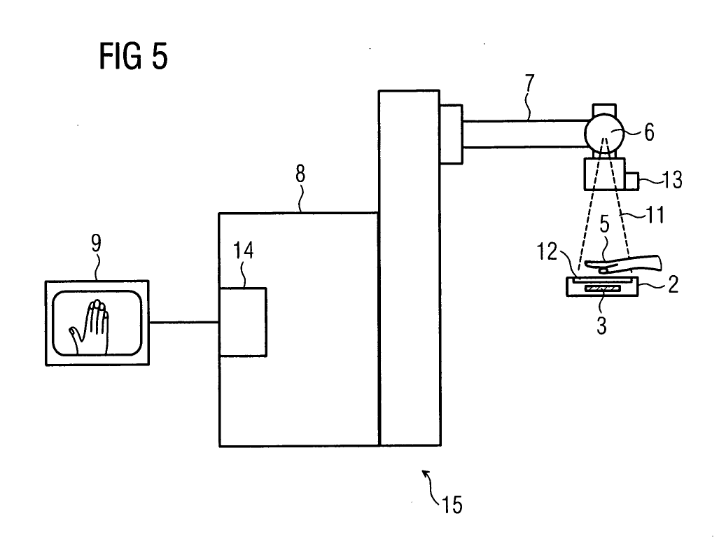

When the electronic data are transmitted in the known case to the control device 8 or to the processing and storage unit 10, the X-ray image is displayed on the display apparatus 9 in relation to the detector orientation point 4 arranged on the solid state detector. But because of the arbitrary orientation of the solid state detector in relation to the X-ray system 1 or the X-ray source 6, it is displayed in a correspondingly arbitrary orientation. However, since the user, for example the doctor, desires—as shown in FIG. 4, for example,—the same accustomed display position for each X-ray image, in the known case each X-ray image is rotated manually by the user on the display apparatus 9 until the display position is reached. This is omitted only when the locational position of the right hand 5 on the X-ray image corresponds by chance to the display position.

FIG. 5 shows an inventive X-ray system 15 in which a device for image recognition and a device for image processing are formed jointly by a processing and storage unit 14 that is provided for image recognition and image processing and on which software is stored. It is also possible to provide a separate arrangement of the device for image recognition and the device for image processing, for example in different processing and storage units.

After the acquisition of the X-ray image of the right hand 5, the processing and storage unit 14 provided for image recognition and image processing detects the locational position of the organ on the X-ray image. This is advantageously performed by way of detecting the locational position of the organ with the aid of a pattern recognition of the organ on the X-ray image or with the aid of a pattern recognition such as, for example, a black and white or a gray scale pattern recognition of the organ on the X-ray image.

Other methods of image recognition can also be applied. Once the outer contour of the right hand 5 is determined, the information stored in the processing and storage unit 14 provided for image recognition and image processing is then used to detect the locational position of the right hand 5 on the X-ray image. This can be performed, for example, by matching with example images of variously positioned right hands. Subsequently, the processing and storage unit 14 provided for image recognition and image processing processes the X-ray image, for example rotates it, and displays it pictorially on the display apparatus 9 such that the organ on the X-ray image is displayed in the display position prescribed by the user. The desired display position can be prescribed by the user, for example before the X-ray system 15 is commissioned, and set as standard.

Additionally, the X-ray system 1 can have a position detection system 13 that detects the locational position of the right hand 5. The position detection system 13 includes, for example, a camera that is arranged in the vicinity of the X-ray source 6 at a collimator or a diaphragm device, and acquires an image of the right hand 5. The position detection system 13 detects the positional orientation of the right hand 5 on the solid state detector, and therefore of the right hand 5 on the X-ray image, for example relative to the detector orientation point 4, or relative to the carry handle 3 of the solid state detector. The position detection system 13 relays the information relating to the locational position to the processing and storage device 14 of the X-ray system 15 such that the information relating to the locational position can be transmitted appropriately to the X-ray image.

If the X-ray system 15 or the processing and storage device 14 provided for image recognition and image processing does not know which organ is the imaged organ, a prior automatic identification of the organ can advantageously be provided as basis for the detection of the locational position of the organ on the X-ray image. For example, the organ is identified automatically by matching with stored exemplary images, this being done by the device for image recognition in the form of the processing and storage device 14 provided for image recognition and image processing.

In order to facilitate the identification of the organ and to reduce or even minimize errors, it is advantageous to use information relating to the respective image acquisition parameters for the purpose of automatically identifying the organ. Thus, for example, it is possible to use the following information, which can be provided by the X-ray system: the position and setting of a diaphragm forming the X-ray beam, the size and position of the introduced X-ray beam 11, an organ program, a deflection or swiveling of the X-ray source 6, a use of an anti-scatter grid, a type and a mode of the X-ray system 15, a spacing between the solid state detector 2 and X-ray source 6, and further generator acquisition parameters. This information can also be used by the device for image recognition to detect the positional orientation of the organ on the X-ray image.

The X-ray system 15 expediently has an additional device for identifying the organ for the purpose of simple and fast identification. Such a device for identification can be formed, for example, by a sensor for measuring the surface loading on the solid state detector 2, or by a sensor for measuring the heat surface on the solid state detector. According to one refinement of an embodiment of the invention, the device for image recognition provides information of the device for identifying the organ as basis for the detection of the locational position of the organ on the X-ray image.

At least one embodiment of the invention may be summarized briefly in the following way: In order to render a simple diagnosis by way of a customary display easier for a user, it is provided in the case of an X-ray system including an assigned, in particular mobile solid state detector, an X-ray source producing an X-ray beam, a device for image recognition, a device for image processing and a display apparatus, that an X-ray image of an organ read out from the mobile solid state detector and detected by the device for image recognition with regard to a locational position of the organ on the X-ray image is automatically displayed pictorially on the display apparatus by the device for image processing in such a way that the organ on the X-ray image exhibits a prescribable display position.

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. An X-ray system, comprising:
an assigned solid state detector;
an X-ray source to produce an X-ray beam;
means for image recognition;
means for image processing; and
a display apparatus, in which an X-ray image of an organ, that has been read out from the solid state detector and has been detected by the means for image recognition with regard to a locational position of the organ on the X-ray image, is automatically displayable pictorially on the display apparatus by the means for image processing in such a way that the organ on the X-ray image has a prescribable display position.

2. The X-ray system as claimed in claim 1, further comprising an additional position detection system for detecting the locational position of the organ on the X-ray image.

3. The X-ray system as claimed in claim 1, wherein the means for image recognition and the means for image processing are designed as a common processing and storage unit.

4. The X-ray system as claimed in claim 2, wherein the position detection system includes a camera.

5. The X-ray system as claimed in claim 1, wherein the means for image recognition exhibits a detection of the locational position of the organ with the aid of at least one of the outer contours, the area and the surface of the organ on the X-ray image.

6. The X-ray system as claimed in claim 1, wherein the means for image recognition exhibits a detection of the locational position of the organ with the aid of a pattern recognition of the organ on the X-ray image.

7. The X-ray system as claimed in claim 1, wherein the means for image recognition includes a prior automatic identification of the organ as basis for the detection of the locational position of the organ on the X-ray image.

8. The X-ray system as claimed in claim 7, wherein respective acquisition parameters of the X-ray system form a basis for the identification of the organ.

9. The X-ray system as claimed in claim 1, further comprising additional means for the identification of the organ.

10. The X-ray system as claimed in claim 9, wherein the identification of the organ by the means for identification forms for the means for image recognition a basis for the detection of the locational position of the organ on the X-ray image.

11. A method for acquiring and displaying an X-ray image by use of an X-ray system including an assigned solid state detector and an X-ray source to produce an X-ray beam, the method comprising:
acquiring, via the solid state detector, an X-ray image of an organ transirradiated by the X-ray beam;
detecting the X-ray image with regard to a locational position of the organ on the X-ray image; and
automatically displaying the X-ray image pictorially in such a way that the organ on the X-ray image is in a prescribable display position.

12. The method as claimed in claim 11, wherein an additional position detection system assigned to the X-ray system (15) detects the locational position of the organ on the X-ray image.

13. The method as claimed in claim 11, wherein a common processing and storage unit detects the X-ray image with regard to a locational position of the organ on the X-ray image and automatically displays it pictorially in such a way that the organ on the X-ray image is in a prescribable display position.

14. The method as claimed in claim 12, wherein the locational position of the organ on the X-ray image is detected by a position detection system including a camera.

15. The method as claimed in claim 11, wherein the locational position of the organ is detected with the aid of at least one of the outer contours, the area and the surface of the organ on the X-ray image.

16. The method as claimed in claim 11, wherein the locational position of the organ is detected with the aid of a pattern recognition of the organ on the X-ray image.

17. The method as claimed in claim 11, wherein the organ is automatically identified and the locational position of the organ is detected on the X-ray image on the basis of the identification.

18. The method as claimed in claim 17, wherein the organ is automatically identified with the aid of respective acquisition parameters of the X-ray system.

19. The method as claimed in claim 11, wherein an additional device is used for the identification of the organ.

20. The method as claimed in claim 19, wherein the locational position of the organ on the X-ray image is detected on the basis of the identification of the organ by the additional device.
